(19) United States
(12) Patent Application Publication
(10) Pub. No.: US 2021/0377389 A1
(43) Pub. Date: Dec. 2, 2021

(54) ROBOCALL SCREENING TOOL IN A COMMUNICATION NETWORK

(71) Applicant: Level 3 Communications, LLC, Broomfield, CO (US)

(72) Inventor: Claudia M. COMBELLAS, Centennial, CO (US)

(21) Appl. No.: 17/226,844

(22) Filed: Apr. 9, 2021

Related U.S. Application Data
(60) Provisional application No. 63/031,170, filed on May 28, 2020.

(51) Int. Cl. H04M 3/436; H04W 4/16

(52) U.S. Cl. CPC H04M 3/4365; H04W 4/16

(57) ABSTRACT

Aspects include systems and methods for screening robocalls from connecting to a target communication device by a robocall screening system. The robocall screening system may receive communications intended for the target communication device and, prior to making the connection, initiate a screening procedure which may involve playing an automated request to the originating device to enter additional information such as an additional digit (or digits), which would normally be achieved through a touchscreen, keypad, voice recognition system, etc. of a communication device. As robocalls are typically originated by an automated dialer that is not equipped or configured to respond to such an automated request, the robocalling device will fail to enter the requested additional information. If the additional information is not entered, the robocall screening system may terminate the communication as an attempted robocall, include routing the communication to a proxy receiving device for further processing.

### CROSS-REFERENCE TO RELATED APPLICATION

This application is related to and claims priority under 35 U.S.C. § 119(e) from U.S. Patent Application No. 63/031,170, filed May 28, 2020 entitled “ROBOCALL SCREENING TOOL IN A COMMUNICATION NETWORK,” the entire contents of which is incorporated herein by reference for all purposes.

### TECHNICAL FIELD

Embodiments of the present invention generally relate to systems and methods for implementing a telecommunications network, and more specifically for screening and controlling automatic voice communications (or robocalling) via a telecommunications network.

### BACKGROUND

A “robocall” is a prerecorded or other form of digital message from a computerized auto-dialer. To initiate a robocall, a user programs a computing device to autodial multiple receiving communication devices and play the prerecorded information when the call is received by the receiving device. Through robocalls, information may be provided to a large segment of a population without requiring a person or group of people to place each call individually.

Robocalls, however, are aggravating to many people and may be even be made with malicious intent. For example, telemarketers often use robocalls in an attempt to sell goods over the phone, which calls can be distracting, frustrating, and in egregious situations overwhelm a person's communication device. In other examples, the recorded message played at the beginning of a robocall may be designed to obtain secret or personal information, such as a receiver's social security number or bank information, to appropriate the receiver's identity or for other nefarious purposes. In still other examples, robocalls may be used as part of a denial of service (DOS) attack on a networking device by exploiting the autodialing feature of the robocalling computing device to direct multiple calls at a target to overwhelm that target's communication ports. Preventing malicious robocalls from reaching a targeted end communication device may aid the network in preventing or reducing ill-intentioned robocalls and improving the experience of users of the network from receiving unwanted robocalls.

It is with these observations in mind, among other, that aspects of the present disclosure were conceived.

### SUMMARY

One aspect of the present disclosure relates to a method for operating a telecommunications network. The method may include the operations of obtaining, from a communication intended for a destination device, a destination device identifier and an origination device identifier and activating an automated message to request a non-automated input from an origination device associated with the origination device identifier. The method may also include the operations of updating, upon receiving the non-automated requested input, a white list associated with the destination device to include the origination device identifier, the white list comprising identifiers of verified origination devices and routing, based on receiving the non-automated requested input, the communication to the destination device.

Another aspect of the present disclosure relates to a method for operating a telecommunications network. The method may include the operations of obtaining, at a network device and from a communication intended for a destination communication device, an origination device identifier, activating a screening protocol requesting a non-automated input, and terminating or connecting the communication based on whether or not the non-automated input is received.

Yet another aspect of the present disclosure relates to a networking device comprising a communication port receiving a communication intended for a destination device, the communication comprising a destination device identifier and an origination device identifier, at least one hardware processor, and at least one memory to store executable instructions. The instructions, when executed, may cause the computing device to activate of an automated screening protocol to request a non-automated input from an origination device associated with the origination device identifier, update, upon receiving the non-automated requested input, a white list associated with the destination device to include the origination device identifier, and transmit, based on receiving the non-automated requested input, the communication to the destination device.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 schematic diagram illustrating an exemplary Internet Protocol (IP) operating environment in accordance with one embodiment.

FIG. 2 is a flowchart illustrating a first method for screening and processing robocalls intended for a receiving device of a communications network in accordance with one embodiment.

FIG. 3 is a flowchart illustrating a second method for screening and processing robocalls intended for a receiving device of a communications network in accordance with one embodiment.

FIG. 4 is a schematic diagram illustrating a robocall screening system for preventing robocalls from being connected to an end device in accordance with one embodiment.

FIG. 5 is a diagram illustrating an example of a computing system which may be used in implementing embodiments of the present disclosure.

### DETAILED DESCRIPTION

Aspects of the present disclosure involve systems, methods, and the like, for screening robocalls or other communications generated by an originating “robocalling” device from connecting to a target communication device. In one implementation, a robocall screening system may be implemented in or otherwise associated with a communication network. The robocall screening system may receive communications intended for the target communication device and, prior to making the connection, initiate a screening procedure which may involve playing an automated request to the originating device to enter additional information such as an additional digit (or digits), which would normally be achieved through a touchscreen, keypad, voice recognition system, etc. of a communication device. As robocalls are typically originated by an automated dialer that is not equipped or configured to respond to such an automated request, the robocalling device will fail to enter the requested additional information. If the additional information is not entered, the robocall screening system may terminate the communication as an attempted robocall. Such termination may include routing the communication to a proxy receiving device for further processing, such as logging the telephone number associate with originating device. If the additional information is entered as requested, e.g., when it is not from an automated dialer and a person enters the requested information, the robocall screening system connects the communication to the receiving device as dialed. In this manner, the robocall screening system may prevent robocalls from reaching the destination device while legitimate communications from a live person may be connected to the destination device.

In some implementations, the robocall screening system may generate or be provided with a white list of originating telephone numbers that are allowed to be connected to the receiving device without the intervention of the automated message. In one example, the system may access a “contact” list from various possible sources and add that contact list to a white list. In another example, a subscriber to the robocall screening system may access the robocall screening system through a portal (e.g., a secure web site) to provide a list of permissible telephone numbers for inclusion in the white list associated with the subscriber's devices. The white list may be associated with a specific telephone number or may be associated with a set of numbers, such as for an enterprise or the like. If for an enterprise, it is possible to include white lists at various levels of the enterprise as well as for discrete numbers. In another example, the robocall screening system may automatically add originating telephone numbers to the white list upon receiving the requested additional information from the originating device. In other words, upon verification that the originating device is associated with a person and not an automated robocalling device, the originating device may be added to the white list for the receiving device. Subsequent communications from a white listed originating device or number received at the robocall screening system may be verified and connected without the system requesting additional information. In this manner, verified originating telephone numbers may bypass the robocall screening procedure through the addition of the telephone numbers to the white list associated with the receiving device. In some instances, the system may require some number of screenings before adding a number to the white list. In yet other instances, the system may allow the target device to enter a digit or digits prior to terminating the call, which would remove the originating number from the white list. Similarly, the subscriber may remove numbers from the white list through the portal.

In other implementations, the robocall screening system may analyze one or more tokens associated with the communication and connect the communication to the destination device or play the automated screening message based on the one or more tokens. For example, communication network standards have been developed for associating a token or attestation indicator to a received communication based on a verification process performed by the receiving network. The Secure Telephony Identity Revisited (STIR) and Signature-based Handling of Asserted Information using Tokens (SHAKEN) are two examples of developed standards for networks receiving a communication to verify the authenticity of the originating telephone number to prevent or combat spoofing of telephone numbers in automated calling. The STIR standard adds a digital certificate to the Session Initiation Protocol (SIP) information of a received communication that indicates a verification level of the received communication. The SHAKEN standard provides for a similar attestation token for inclusion with a transmitted communication. The robocall screening system may therefore obtain and analyze the attestation associated with a received communication and process the communication based on the attestation token. In one example, an attestation token indicating a first level of verification may be connected to the destination device while an attestation token indicating a second level of verification may cause the screening system to play the automated message requesting additional dialing information. The robocall screening system may perform various processes based on any number of levels of verification indicated by the attestation token.

Through the operations and systems described herein, the robocall screening system may reduce the number of robocalls received at a destination device of a communication network. Through screening and terminating detected robocalls, the screening system may improve the operation of the communication network and the experience of using the network by users of connected communication devices.

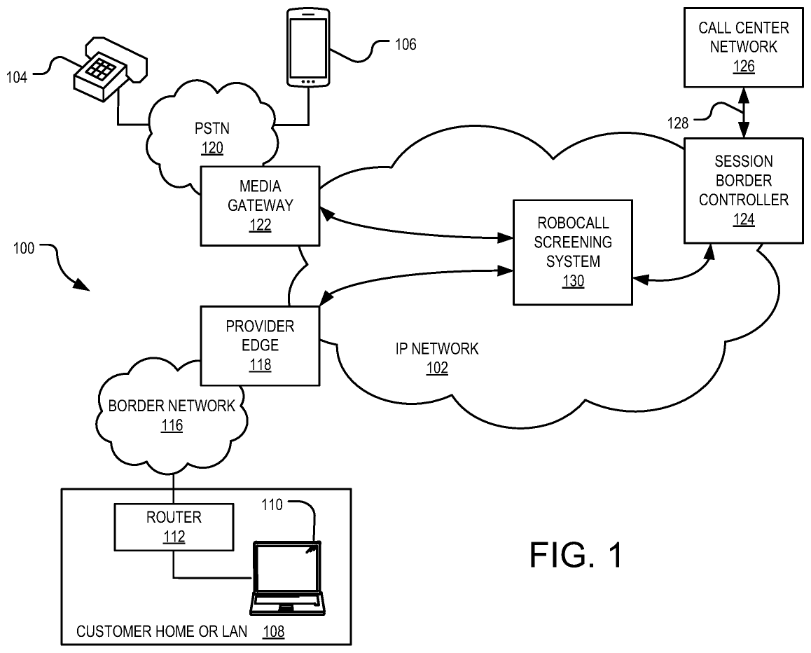

FIG. 1 illustrates an exemplary operating environment 100 for processing and screening robocalls transmitted through a network 102. In general, the environment 100 provides for establishing communication sessions between network users and for providing one or more network services to network users. For example, users may utilize the network 102 to communicate via the network using communication devices, such as telephone devices 104 and/or mobile communication devices 106. In another example, the network environment 100 may facilitate communications between networks managed or administered by separate entities, such as communications between IP network 102 and call center network 126. With specific reference to FIG. 1, the environment 100 includes an IP network 102, which may be provided by a wholesale network service provider. However, while the environment 100 of FIG. 1 shows a configuration using the IP network 102, it should be appreciated that portions of the network may include non IP-based routing. For example, network 102 may include devices utilizing time division multiplexing (TDM) or plain old telephone service (POTS) switching. In general, the network 102 of FIG. 1 may include any communication network devices known or hereafter developed.

The IP network 102 includes numerous components such as, but not limited to gateways, routers, route reflectors, and registrars, which enable communication and/or provides services across the IP network 102, but are not shown or described in detail here because those skilled in the art will readily understand these components. The IP network 102 may also include a robocall screening system 130 to identify and route one or more robocalls received from call center network 126, as discussed in more detail below. Communications between the IP network 102 and other entities or networks, such as the one or more customer home or business local area networks (LANs) 108, may also be managed through network environment 100.

Customer network 108 can include communication devices such as, but not limited to, a personal computer or a telephone 110 connected to a router/firewall 112. Although shown in FIG. 1 as computer 110, the communication devices may include any type of communication device that receives a multimedia signal, such as an audio, video or web-based signal, and presents that signal for use by a user of the communication device. The communication and networking components of the customer network 108 enable a user at the customer network to communicate via the IP network 102 to other communication devices, such as another customer network and/or the call center network 126. Components of the customer network 108 are typically home- or business-based, but they can be relocated and may be designed for easy portability. For example, the communication device 110 may be wireless (e.g., cellular) telephone, smart phone, tablet or portable laptop computer. In some embodiments, multiple communication devices in diverse locations that are owned or operated by a particular entity or customer may be connected through the IP network 102.

The customer network 108 typically connects to the IP network 102 via a border network 116, such as one provided by an Internet Service Provider (ISP). The border network 116 is typically provided and maintained by a business or organization such as a local telephone company or cable company. The border network 116, also referred to as a peer network, may provide network/communication-related services to their customers. Other communication devices, such as telephonic device 104 and/or mobile device 106, may access and/or be accessed by, the IP network 102 via a public switched telephone network (PSTN) 120 operated by a local exchange carrier (LEC). Communication via any of the networks can be wired, wireless, or any combination thereof. The telephonic device 104, mobile device 106, and/or computing device 110 may further utilize the IP network 102 to communicate with or otherwise access the call center network 126 to provide and obtain data.

Call center network 126 may connect to IP network 102 through a dedicated trunk group connection 128. In other words, the call center network 126 may request and receive a trunk group connection 128 to the IP network 102 that includes multiple connection lines into the network that is not shared with other customers to the IP network. Services and/or support for the call center network 126 may be provided by the IP network 102 through application of the services on each communication received via the dedicated trunk group 128 as each communication must be provided to the IP network 102 from the call center network 126. In some instances, the call center network 126 may include one or more computing devices configured or programmed to generate robocalls to the IP network 102 via trunk group 128. The computing devices of the call center network 126 may be any type of computing device configured to autodial a pre-programmed telephone number associated with a destination communication device, such as cellular phone 106 or customer device 110. The autodialed communication, or robocall, may be provided to the destination device as described in more detail below. Once connected, a pre-recorded message may be played over the connection between the communication devices by the robocall computing device of the call center network 126. In this manner, the computing devices of the call center network 126 may place multiple robocalls via trunk group 128 to any destination devices connected or accessible via the IP network 102.

Networks, such as the call center network 126, border network 116, and/or PSTN 120, may connect to IP network 102 through one or more interface or edge devices. Interface devices may include, but are not limited to, provider edge device 118, media gateway device 122, and/or session border controller 124. For ease of instruction, only three external networks 126, 116, and 120 are shown communicating with the IP network 102; however, numerous such networks, and other devices, may be connected with the network 102, which is equipped to handle enormous numbers of simultaneous calls and/or other IP-based communications.

As mentioned, IP network 102 may include a robocall screening system 130 for receiving and screening potential robocalls provided to the IP network 102 from call center network 126 via session border controller (SBC) 124. In some instances, the components and functions of the robocall screening system 130 may be incorporated or executed by SBC 124 upon ingress of robocalls from the call center network 126 via trunk group 128. In other instances, robocall screening system 130 may be embodied on one or more components of network 102, such as one or more application servers or other networking devices of the network 102, and/or one or more devices connected to the network 102, such as cellular device 106 or computing device 110. In general, all or portions of the robocall screening system 130 may be included in any component of the IP network 102 or associated with the network. In still another example, the robocall screening system 130 may not be included in the IP network 102. Rather, the robocall screening system 130 may connect to or otherwise communicate with trunk group 128 to receive the robocalls from the call center network 126 to identify and process the robocalls.

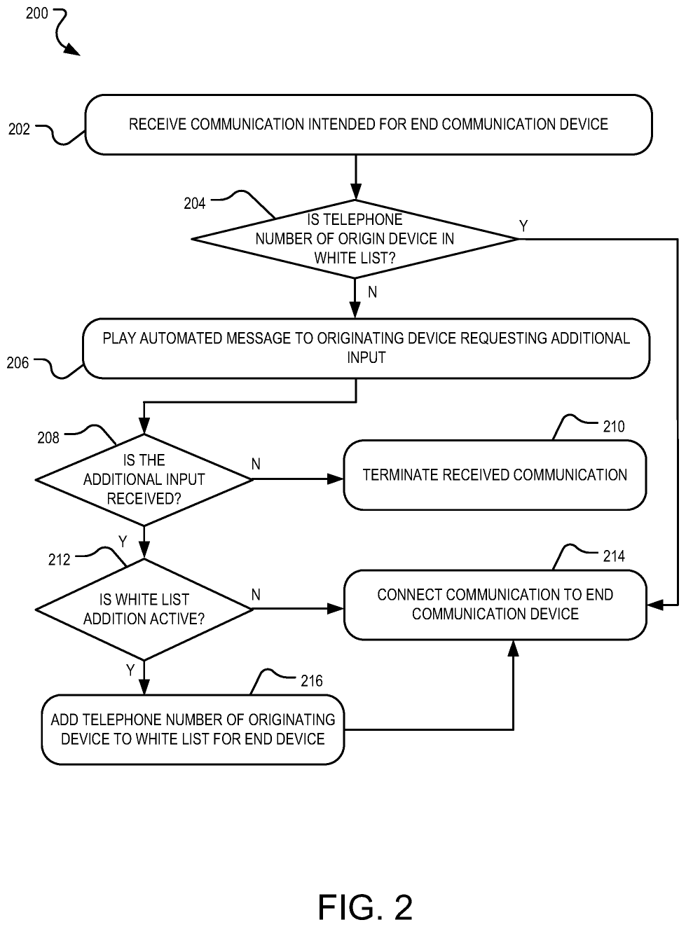

FIG. 2 is a flowchart illustrating a first method 200 for screening and processing robocalls intended for a receiving device of a communications network 102 in accordance with one embodiment. In one instance, the operations of the method 200 may be performed by the robocall screening system 130 of the network 102. However, one or more of the operations may be performed by other components of the network 102 or devices in communication with the network, such as a destination device for a communication. The operations may be performed through one or more hardware components, one or more software programs, or a combination of hardware and software components of the above mentioned devices.

In operation 202, the robocall screening system 130 may receive a communication intended for an end or destination communication device in communication with the network 102. For example and utilizing the network environment 100 of FIG. 1 as an example, call center network 126 may generate a robocall, utilizing an automated dialer device, for cellular device 106 connected to network 102 via PSTN 120. To generate the robocall, the auto-dialer may dial a destination telephone number associated with the cellular device 106. The auto-dialer device and/or the call center network 126 may also have an assigned originating telephone number when transmitting the robocall communication. The originating telephone number and the destination telephone number may both be included with the communication, such as in a header of a communication packet. The robocall screening system 130 may obtain the destination telephone number and the originating telephone number from the communication upon receiving the communication.

In operation 204, the robocall screening system 130 may determine if a white list screening option is active for a customer associated with the destination telephone number. More particularly, customers to the network 102 may obtain or request a robocall screening service from the network 102. Upon request, the robocall screening system 130 may generate a customer profile for each destination telephone number associated with the screening service. In this manner, a customer may request the screening service for one or more telephone numbers associated with the customer's devices. The robocall screening system 130 may maintain a database of customer telephone numbers and the services associated with those telephone numbers. In one particular implementation, the customer may request a white list service from the screening system 130. In general, a white list provides a list of verified or allowed originating telephone numbers to be connected to the destination device without additional screening by the screening system 130. As explained above, the robocall screening system 130 may intercept communications intended for a destination device and play an automated message to the originating device to request additional inputs, perhaps via a keypad of the originating device, to connect to the destination device. If the additional inputs are not received or entered, the originating device is not connected to the destination device. Alternatively, the devices may be connected upon receipt of the additional inputs from the originating device.

In addition to requesting the additional inputs, the robocall screening system 130 may also provide a white list associated with destination telephone numbers or devices. In general, a white list is a list of telephone numbers that the system 130 connects to the destination device without requesting the additional inputs. The list of originating telephone numbers included in the white list may be received from a customer of the network 102 associated with the destination device. Thus, the white list may be associated with a destination telephone number, a destination device identifier, a customer number, and the like. The white list may be provided by the customer in many ways, including through a user input in communication with the robocall screening system 130 as discussed below. In another example, the white list may be provided to a network administrator 102 for uploading to the robocall screening system 130. Regardless of how the white list of obtained, the robocall screening system 130 may determine, in operation 204, if a communication intended for a destination device is received from a originating telephone number that is included in the white list of that destination device for processing of the communication. More particularly, the robocall screening system 130 may obtain the destination device telephone number from the received communication. Based on the destination device telephone number, the robocall screening system 130 may obtain a white list of allowed originating telephone numbers associated with the destination telephone number. If the telephone number of the originating device as included or associated with the communication is in the white list of allowed telephone numbers associated with the destination telephone number, the robocall screening system 130 may transmit the communication to the destination device in operation 214 to connect the devices for an exchange of packets between the devices. In this manner, the white list may bypass the screening procedure described herein of requesting additional inputs from the originating device before connection.

If, in operation 204, the originating telephone number of the origin device is not included in the white list associated with the destination telephone number, the robocall screening system 130 may play the automated message to the originating device to request an additional input be provided by the originating device in operation 206. In one implementation, the requested additional input may include pressing a number on a keypad of the originating device. For example, the automated message may request a user of the originating device to press “1” to complete the call to the destination device. Other implementations may request a string of any number of digits entered through a keypad or other input device of the originating device. In still further implementations, the requesting additional input may be randomly generated by the robocall screening system 130 to prevent an auto-dialing device from posing as a human user of the originating device. Other inputs from other originating devices, such as a password, alphanumeric string, encryption key, and the like may be requested as inputs in other implementations. Other types of input devices may also be used to provide the requested inputs. In some implementations, the robocall screening system 130 may include a voice recognition program such that the additional input may include a verbal phrase such and input of the additional information may include a verbal utterance of the information.

Upon playing of the automated message, the robocall screening system 130 may determine if the additionally requested input is received in operation 208 through one or more of the input devices discussed above. If the additional input is not received, the robocall screening system 130 may terminate the received communication in operation 210. Termination of the communication may include dropping the communication from the network 102, routing the communication to a mitigating device for additional processing (including logging of information of the attempted robocall and playing of an additional message of the failure to provide the additional input), and/or reporting the originating telephone number to a database of known telephone numbers associated with robocalling.

If the requested additional input is received, the robocall screening system 130 may determine, in operation 212, if a white list updating option is active for the customer associated with the destination device. In one implementation, the robocall screening system 130 may include a white list updating option to provide for updating to the white list associated with the destination device based on the processing of received communications by the screening system. The white list update option for a customer's white list may be activated through a request received by the customer, such as via a user interface or from a communication received by the network administrator. In some instances, the white list updating option may be automatically associated with each or some white lists maintained by the robocall screening system 130. In general, the white list updating service provides for telephone numbers or other identifiers associated with originating devices to be added to a customer's white list upon receiving the requested additional input from the originating device. In this manner, an originating device may need to verify itself to the robocall screening system 130 once and be added to the white list for that destination telephone number. If the white list updating service is not active as determined in operation 212, the robocall screening system 130 may connect the originating device to the destination device in operation 214 by transmitting the received communication to the destination device. However, if the white list updating service is active, the robocall screening system 130 may add the originating device telephone number as obtained from the communication to the white list associated with the destination device in operation 216. The updating of the white list for the destination telephone number may occur without additional input or approval from a customer associated with the destination device. Upon updating of the white list, the robocall screening system 130 may proceed to operation 214 and connect the originating device and the end device for the exchange of communication.

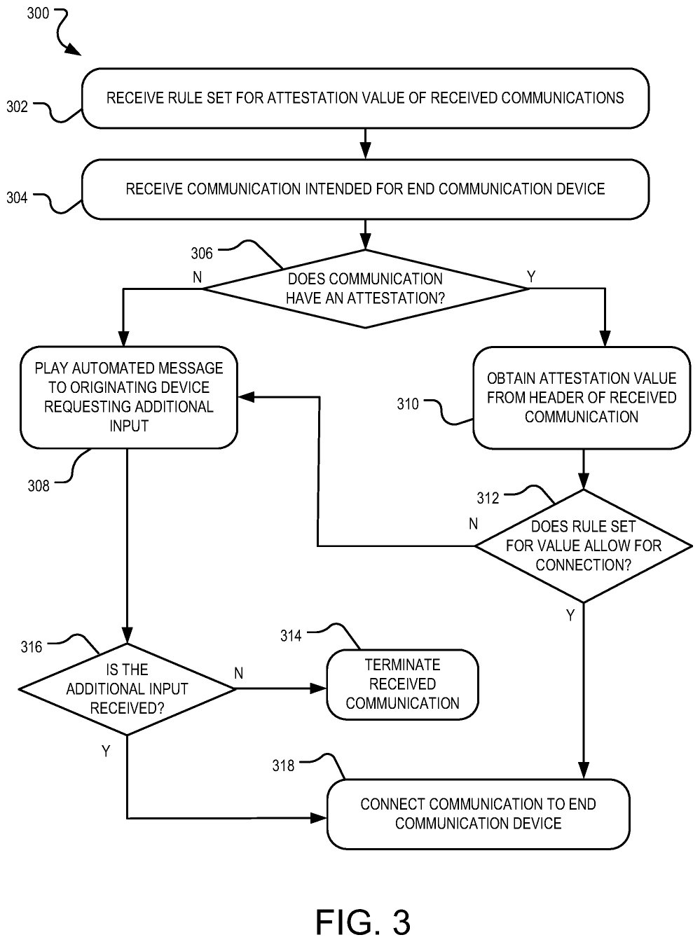

Through the method 200 of FIG. 2, the robocall screening system 130 may screen robocalls from reaching a destination device and prevent the negative effects of such robocalls. Further, the method 200 may provide for generation, use, and updating of a white list of allowed or permitted originating telephone numbers to bypass the additional screening for incoming communications to the destination device. FIG. 3 is a flowchart illustrating a second method 300 for screening and processing robocalls intended for a receiving device of a communications network in accordance with one embodiment. As above, the operations of the method 300 may be performed by the robocall screening system 130 of the network 102 or by other components of the network 102 or devices in communication with the network, such as a destination device for a communication. The operations may be performed through one or more hardware components, one or more software programs, or a combination of hardware and software components of the above mentioned devices.

The method 300 of FIG. 3 generally provides for screening of robocalls using a verification token, value, or other verification attestation including with the communication, such as in the SIP header or other informational portion of the communication. In particular and starting in operation 302, the robocall screening system 130 may receive a rule set for processing a received communication based on one or more attestation values associated with the communication. For example, a STIR/SHAKEN protocol provides for associating one or three attestations to a communication to indicate a level of verification of the originating device of the communication. The high, or “A”, attestation value assigned to a communication indicates a verified origination device, a medium, or “B”, attestation value indicates a partially verified origination device, and a low, or “C”, attestation value indicates an unverified origination device. The rule set provided to the robocall screening system 130 may include processing rules for a received communication based on the attestation value associated with the communication. In the above example, the rule set may provide for allowing a communication to with a high attestation value and initiating the message to input additional information for medium or low attestation values. Other rule sets may provide for alternative processing of the communication, such as allowing communications with a medium attestation. The rule set may provide for any processing decisions of the robocall screening system 130 based on the attestation values.

In one implementation, the rule set may be a global rule set for each communication received by the robocall screening system 130. In another implementation, the rule set may be unique to the destination telephone number to which the rule set is associated and may be different than other rules sets maintained by the screening system 130. The rule set may be provided to the robocall screening system 130 by a network administrator to control the processing of communications by the system. In other implementations, the rule set may be established by a user of the network 102 based on needs of the customer and provided to the robocall screening system 130 via an upload, such as through a user interface. Regardless of how the rule set is provided to the screening system 130, the system may maintain the rule set for the destination telephone number to process received communications according to the attestation values of the communications.

In operation 304, robocall screening system 130 may receive a communication intended for a destination device and obtain information of the communication from one or more fields of the communication. For example, the system 130 may obtain an origination telephone number, a destination telephone number, and/or an attestation value of the communication. In particular, the robocall screening system 130 may, in operation 306, determine if the communication includes an attestation value indicating a verification of the origination of the communication. If the communication does not include an attestation value, the robocall screening system 130 may proceed to operation 308 and play the automated message to the originating device to obtain an additional input from the originating device as described above.

Alternatively, if the communication includes an attestation value, the robocall screening system 130 may obtain the value from one or more information fields of the communication in operation 310. For example, the attestation value may be obtained from a SIP header of the communication. In operation 312, the robocall screening system 130 may use the rule set for processing the attestation value to determine if the rule set provides for allowing connection of the received communication. For example, the rule set may establish that an “A” attestation value may be allowed to connect, while a “B” or “C” attestation value communication is not to be automatically connected. If the rule set provides for connecting the communication to the destination device based on the attestation value, the robocall screening system 130 may proceed to operation 318 and transmit the communication to the destination device to connect the communication between the devices. If the rule set determines that the attestation value calls for additional screening by the system 130, the system may proceed to operation 308 and play the automated message requesting additional information, as described above.

Upon playing of the automated message, the robocall screening system 130 may determine if the additionally requested input is received in operation 316 through one or more of the input devices discussed above. If the additional input is not received, the robocall screening system 130 may terminate the received communication in operation 314 and as described above. If the requested additional input is received, the robocall screening system 130 may connect the originating device to the destination device in operation 318 by transmitting the received communication to the destination device for the exchange of communications. Through the method 300 of FIG. 3, the robocall screening system 130 may process received communications based on an attestation value or token associated with the received communication.

In addition, some implementations of the robocall screening system 130, the attestation value rule set and the white list may both be utilized when processing a received communication as a potential robocall. In particular, the screening system 130 may first process an attestation value associated with a received communication based on an attestation value rule set. If the automated message to request additional input is played and the additional input is received, the robocall screening system may then add the originating telephone number to the white list associated with the destination telephone number. In other implementations, the robocall screening system 130 may compare a telephone number of the originating device of a received communication to a white list before obtaining the attestation value from the communication.

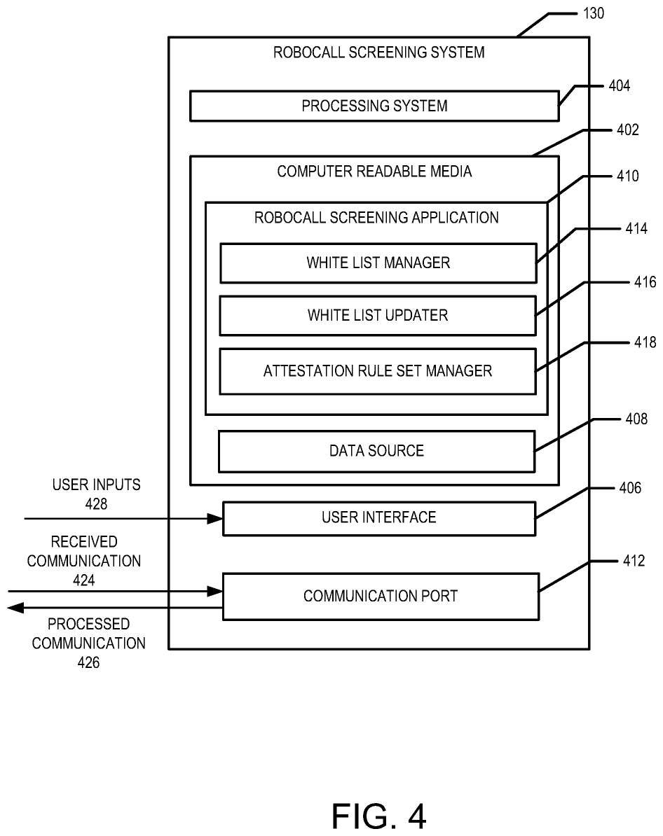

FIG. 4 is a schematic diagram illustrating a robocall screening system 130 for screening robocalls received at a communications network 102. The robocall screening system 130 of FIG. 4 may be the robocall screening system 130 for screening robocalls received at network 102 from call center network 126 via trunk group 128. In some instances, a robocall screening application 410 may be executed on the robocall screening system 130 to perform one or more of the operations described herein. The robocall screening application 410 may be stored in a computer readable media 402 (e.g., memory) and executed on a processing system 404 of the robocall screening system 130 or other type of computing system, such as that described below. For example, the robocall screening application 410 may include instructions that may be executed in an operating system environment, such as a Microsoft Windows™ operating system, a Linux operating system, or a UNIX operating system environment. The computer readable medium 402 includes volatile media, nonvolatile media, removable media, non-removable media, and/or another available medium. By way of example and not limitation, non-transitory computer readable medium 402 comprises computer storage media, such as non-transient storage memory, volatile media, nonvolatile media, removable media, and/or non-removable media implemented in a method or technology for storage of information, such as computer readable instructions, data structures, program modules, or other data.

According to one embodiment, the robocall screening system 130 also provides a user interface (e.g., a command line interface (CLI), a graphical user interface (GUI), etc.) 406 displayed on a display, such as a computer monitor, for displaying data. Through the user interface 406, a user of the robocall management system 130 may provide inputs 428 through one or more input devices. The inputs 428 may be used to, among other things, configure the components of the robocall screening application 410, set or alter the rule set associated with an attestation token of a communication, activate or alter a white list service associated with a robocall screening system, and the like. The input device for providing the configuration inputs 428 may include, among others, a keyboard or a pointing device (e.g., a mouse, trackball, pen, or touch screen) to enter data into or interact with the user interface 406. The user interface 406 may be accessed from any computing device in communication with the robocall screening system 130. Thus, a user or administrator of the robocall screening system 130 or the IP network 102 may log into the robocall user interface 406 remotely to provide the configuration inputs 428 or to otherwise manage the robocall screening system 130.

The robocall screening application 410 may also utilize a data source 408 of the computer readable media 402 for storage of data and information associated with the robocall screening system 130. For example, the robocall screening application 410 may store information associated with the operations of the robocall screening system 130, including the rule set associated with an attestation token of a communication, white lists associated with customers of the robocall screening application, and the like.

The robocall screening system 130 may also include one or more communication ports through which communications 424 intended for a destination device of the IP network 102 are received. For example, call center network 126 may generate one or more robocalls 424 for transmission to a destination device connected to or otherwise available via the IP network 102. The robocall screening system 130 may receive the communication prior to transmission to the destination device. The received communications 424 may be processed by the robocall screening system 130 as described herein to execute some type of action on the received communication, including routing the communication based on a white list or other consideration, blocking the communication, and the like. The robocall screening system 130 may utilize the communication port 412 to transmit the processed communication 426 for routing to one or more destinations as described herein. In some instances, the robocall screening system 130 may transmit one or more routing instructions via the communication port 412 to one or more components of the IP network 102 to execute the transmission of the communication based on the processing of the communication.

In addition, the robocall screening application 410 may include several components to perform one or more of the operations described herein. For example, the robocall screening application 410 may include a white list manager 414 for maintaining and managing white lists associated with the robocall screening system 130. For example, the white list manager 414 may correlate received white lists to one or more destination telephone numbers, customer number, destination device identifiers, and the like. The white list manager 414 may also store the received white lists, and the correlated destination device telephone number and the like, in the data source 408 of the robocall screening system 130. The robocall screening application 410 may also include a white list updater component 416 for updating one or more stored white lists based on receiving a requested additional input from an originating device as described above. In some implementations, the white list updater 416 may determine updates to one or more white lists and provide the update to the white list manager 414 for inclusion in a stored white list. The white list updater may also provide an identifier of the white list to be updated with the originating telephone number that provides the requested additional input to the white list manager 414. In this manner, the white list manager 414 and the white list updater 416 may work in tandem to update one or more stored white lists of the robocall screening system 130.

The robocall screening application 410 may also include an attestation rule set manager 418 to manage one or more received attestation rule sets. As described above, the attestation rule set may be used to determine processing of a received communication by the robocall screening system 130. More particularly, the attestation rule set may determine if the communication is transmitted to the destination device or terminated based on an attestation value associated or included with the received communication. Similar to the white list manager 414, the attestation rule set manager 418 may receive rule sets (perhaps via the user interface 406), associate the rule sets with one or more destination devices (such as destination device telephone numbers, identifiers, customer numbers, and the like), and store the associated rule set and destination device in the data source 408.

It should be appreciated that the components described herein are provided only as examples, and that the application 410 may have different components, additional components, or fewer components than those described herein. For example, one or more components as described in FIG. 4 may be combined into a single component. As another example, certain components described herein may be encoded on, and executed on other computing systems, such as on one remotely coupled to the robocall screening system 130.

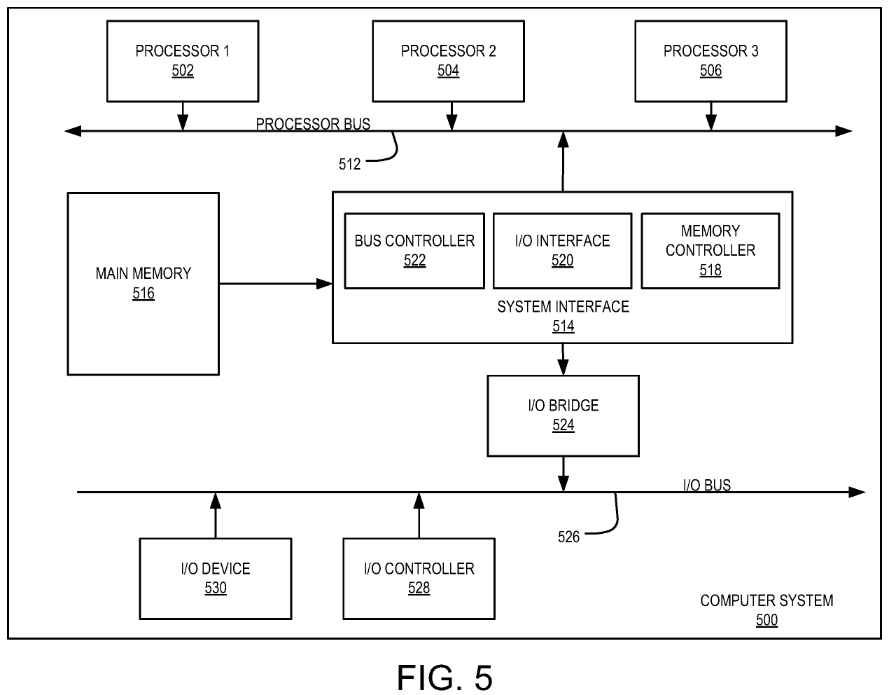

FIG. 5 is a block diagram illustrating an example of a computing device or computer system 500 which may be used in implementing the embodiments of the components of the network disclosed above. For example, the computing system 500 of FIG. 5 may be the robocall screening system 130 discussed above. The computer system (system) includes one or more processors 502-506. Processors 502-506 may include one or more internal levels of cache (not shown) and a bus controller or bus interface unit to direct interaction with the processor bus 512. Processor bus 512, also known as the host bus or the front side bus, may be used to couple the processors 502-506 with the system interface 514. System interface 514 may be connected to the processor bus 512 to interface other components of the system 500 with the processor bus 512. For example, system interface 514 may include a memory controller 514 for interfacing a main memory 516 with the processor bus 512. The main memory 516 typically includes one or more memory cards and a control circuit (not shown). System interface 514 may also include an input/output (I/O) interface 520 to interface one or more I/O bridges or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system set forth in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

We claim:

1. A method for operating a telecommunications network, the method comprising:
obtaining, from a communication intended for a destination device, a destination device identifier and an origination device identifier;
activating an automated message to request a non-automated input from an origination device associated with the origination device identifier;
updating, upon receiving the non-automated requested input, a white list associated with the destination device to include the origination device identifier, the white list comprising identifiers of verified origination devices; and
routing, based on receiving the non-automated requested input, the communication to the destination device.

2. The method of claim 1, wherein the destination device identifier is a telephone number associated with the destination device and the origination device identifier is a telephone number associated with the origination device.

3. The method of claim 1 further comprising:
obtaining a validation attestation value from the communication, wherein routing the communication is further based on the validation attestation value.

4. The method of claim 3, wherein the validation attestation value is one of a Secure Telephony Identity Revisited (STIR) attestation value or a Signature-based Handling of Asserted Information using Tokens (SHAKEN) attestation value.

5. The method of claim 3 further comprising:
accessing a rule set comprising one or more processing operations corresponding to a plurality of validation attestation values; and
determining a processing operation for the communication based on the accessed rule set.

6. The method of claim 5, wherein the rule set is associated with the destination device identifier.

7. The method of claim 5, wherein the rule set is a global rule set for all communications received at the network device.

8. The method of claim 5, wherein the rule set is obtained via a user interface in communication with a network device.

9. A method for operating a telecommunications network, the method comprising:
obtaining, at a network device and from a communication intended for a destination communication device, an origination device identifier;
activating a screening protocol requesting a non-automated input; and
terminating or connecting the communication based on whether or not the non-automated input is received.

10. The method of claim 9, wherein the screening protocol includes playing an automated message requesting the non-automated input in the form of at least one number entered via an input device of an origination device associated with the origination device identifier.

11. The method of claim 9 further comprising:
adding the originating device identifier to a white list when the non-automated requested input is received at the network device.

12. The method of claim 9 further comprising:
activating the screening protocol requesting the non-automated input when the originating device identifier is not in a white list.

13. The method of claim 9, wherein terminating or connecting the communication is further based on a validation attestation value associated with the communication.

14. The method of claim 13, wherein the validation attestation value is one of a Secure Telephony Identity Revisited (STIR) attestation value or a Signature-based Handling of Asserted Information using Tokens (SHAKEN) attestation value.

15. The method of claim 13, wherein activating the screening protocol is based on a rule set comprising one or more processing operations corresponding to a plurality of validation attestation values.

16. A networking device comprising:
a communication port receiving a communication intended for a destination device, the communication comprising a destination device identifier and an origination device identifier;
at least one hardware processor; and
at least one memory to store executable instructions to cause the at least one hardware processor to:
activate an automated screening protocol to request a non-automated input from an origination device associated with the origination device identifier;
update, upon receiving the non-automated requested input, a white list associated with the destination device to include the origination device identifier; and
route, based on receiving the non-automated requested input, the communication to the destination device.

17. The networking device of claim 16, wherein the white list comprises a plurality of identifiers of verified origination devices.

18. The networking device of claim 16, wherein the instructions further cause the at least one hardware processor to:
identify, based on a failure to receive the non-automated input in response to the request for the non-automated input, a second communication as a robocall originating from an automated dialing system.

19. The networking device of claim 18, wherein the instructions further cause the at least one hardware processor to:
route, based on the identifying of the second communication as a robocall, the second communication to a proxy receiving device, the proxy receiving device logging the origination device identifier in a blacklist of identified origination devices.

20. The networking device of claim 18, further comprising:
a user interface communicator receiving at least one identifier of a verified origination device and storing the at least one identifier in the white list.
